(19) United States
(12) Patent Application Publication
(10) Pub. No.: US 2025/0216930 A1
(43) Pub. Date: Jul. 3, 2025

(54) CONTEXTUAL SPACES AND FOCUS MODES

(71) Applicant: Apple Inc., Cupertino, CA (US)

(72) Inventors: Sina Karachiani, San Francisco, CA (US); Shuxin Yu, San Francisco, CA (US)

(21) Appl. No.: 18/966,808

(22) Filed: Dec. 3, 2024

Related U.S. Application Data
(60) Provisional application No. 63/615,597, filed on Dec. 28, 2023.

(51) Int. Cl. G06F 3/01

(52) U.S. Cl. CPC G06F 3/011

(57) ABSTRACT

Methods, devices, and systems, in some implementations, configure an XR environment using a workspace that stores information from a prior activity associated with the workspace (e.g., initial workspace setup or prior use session). The workspace stores info identifying the applications, application states, and application spatial positions/sizes from the prior activity. Note that workspaces are not limited to storing information about occupational work uses, e.g., they may store information about work, educational, recreational, fitness, and other types of uses. The prior activity may be a user session in which the user manually or semi-manually configures and saves the workspace or a user session in which the user just uses an already-created workspace, e.g., repositioning applications, pulling up content in the applications, etc. The use of a workspace may be initiated (a) manually; (b) automatically based on day, time, location, or other context; or (c) automatically based on a focus being triggered.

### CROSS-REFERENCE TO RELATED APPLICATIONS

This application claims the benefit of U.S. Provisional Application Ser. No. 63/615,597 filed Dec. 28, 2023, which is incorporated herein in its entirety.

### TECHNICAL FIELD

The present disclosure generally relates to user experiences with content within a three-dimensional (3D) environment, such as a 3D extended reality (XR) environment provided by a head-mounted device (HMD).

### BACKGROUND

Users of devices that provide 3D environments, such as XR environment provided by HMDs, may use many different types of content and various combinations of content for different uses, e.g., working generally, working on work budget reports, drafting work presentations, meditating, gaming, fitness, etc. For a given purpose, a user may spend significant time arranging content within a 3D environment (e.g., based on preferring a particular spatial arrangement for a given type of use) and may be required to repeat such arrangements each time they use the device for that purpose.

### SUMMARY

Various implementations disclosed herein include devices, systems, and methods that configure an XR environment using one or more workspaces that store information from prior activities associated with each workspace. The prior activity may be an initial workspace setup or changes made to content of a workspace during a prior use session. A workspace may store information identifying the applications, application states, and application spatial positions/sizes from the prior activity. Note that workspaces are not limited to storing information about occupational work uses, e.g., they may store information about work, educational, recreational, fitness, and other types of uses. The prior activity may be a user session in which the user manually or semi-manually configures and saves the workspace or a user session in which the user just uses an already-created workspace, e.g., repositioning applications, pulling up content in the applications, etc. The use of a workspace (e.g., to automatically setup the user's environment for use) may be, as examples, initiated (a) manually; (b) automatically based on day, time, location, or other context; or (c) automatically based on a focus being triggered.

In some implementations, a processor performs a method by executing instructions stored on a computer readable medium of an electronic device (e.g., an HMD) having one or more sensors. The method involves determining to configure a 3D XR environment using a workspace that stores information based on a prior activity associated with the workspace. The workspace may identify states of one or more applications associated with the prior activity or 3D spatial positioning information for user interfaces of the one or more applications during the prior activity. In one example, the prior activity is workspace creation. In such a case, the states and 3D positions may be based on the states and 3D positions of the one or more applications at a time (e.g., the end of) during the workspace creation activity. In another example, the prior activity is a subsequent use of an already-created workspace. In such a case, the states and 3D positions may be based on the states and 3D positions of the one or more applications at a time (e.g., the end of) during that session. The method, in accordance with determining to configure the XR environment using the workspace, involves positioning the user interfaces of the one or more applications in the XR environment based on the 3D spatial positioning information, restoring the one or more applications to the states of the or more applications associated with the prior use, or both. In some implementations, a workspace is triggered (e.g., to configure the user's environment) by an activity, such as a user entering a particular physical environment or location or a user switching to a particular type of focus mode on their device, e.g., work, sleep, relax, etc.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates views of an XR environment provided by the device of FIG. 1 in which the user positions and uses applications, in accordance with some implementations.

FIG. 3 illustrates the user returning to the physical environment of FIG. 1 at a later time, in accordance with some implementations.

FIG. 4 illustrates a view of an XR environment provided by the device of FIG. 3 in which application positioning and content is provided based on application positioning and content from a prior activity associated with a workspace, in accordance with some implementations.

FIG. 5 is a flowchart illustrating a method for positioning applications and restoring application content based on workspace associated with a prior activity, in accordance with some implementations.

FIG. 6 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Users of devices that provide 3D environments such as XR environment provided by HMDs may use many different types of content and various combinations of content for different uses, e.g., working generally, working on work budget reports, learning, creating, drafting work presentations, meditating, gaming, fitness, etc. Users may use multiple applications at a time (or within a single session) to perform a given task or activity. Users may have preferred spatial arrangements of applications for different tasks, particularly in the context of mixed-reality (MR) applications in which application content is positioned relative to views of a physical environment around the user, e.g., via pass-through video. Configuring such applications each time a user wants to perform the task may be time consuming or burdensome for the user.

Some implementations herein enable users to configure one or more workspaces. Each workspace may include one or more applications selected by a user, a stored state of each application, a spatial arrangement for the applications, or combinations of one or more of these features. For example, one workspace may include a web browser application six feet directly in front of a user, a word processing application six feet away and forty-five degrees to the left of the user, and a spreadsheet application six feet away and forty-five degrees to the right of the user. When a user invokes a particular workspace associated with that spatial configuration (or when the workspace is automatically invoked), those three applications may be automatically opened and positioned at their respective distances and orientations from the user's current position. A workspace may specify how applications are positioned, orientated, sized, shaped, or otherwise configured, among other things. The applications may also be in the same states in which they were the last time the workspace was used (e.g., when it was originally created or subsequently used). For example, if the user has a particular document opened in a document editing application and scrolled to a particular page, that application may be executed, and the same document automatically opened and the document scrolled to that page. In some implementations, a user is enabled to have multiple workspaces of their applications and arrangements for various tasks and may be further enabled to switch between those workspaces as they switch activities and tasks throughout a day, week, etc.

In some implementations, workspaces are not associated with physical locations or rooms. Workspaces may, for example, present themselves in the same arrangement relative to a user's location, e.g., using spatial arrangements tied to the user or another reference object. In other implementations, workspaces are associated with physical locations or rooms or otherwise take into account the physical environment around the user in spatially positioning applications according to the workspace's stored spatial arrangement information. A user may have a preferred spatial arrangement for a given workspace when they are in a certain physical location. For example, when using a “work” workspace in the user's home office, they may want the web browser application placed against the back wall of the office, the document editor application to be displayed above their desk, and the spreadsheet application to be displayed on a side wall. When the system detects that the workspace is being invoked in a physical environment that has a custom configuration, it may use the location-specific workspace configuration. This may involve, for example, using a world-locked spatial arrangement and positioning of the applications relative to a coordinate system of the physical environment, rather than using a user-centric or reference object-centric spatial arrangement in positioning the applications. If a workspace does not have a custom (e.g., specified, world-locked) arrangement for that physical location, the application may be presented using their distances/orientations offset from the position of the user or other reference object when the workspace is invoked.

In some implementations, a workspace is associated (e.g., by the user or automatically) with a system environment (e.g., a virtual environment), a particular system/virtual environment immersion level, audio level, or focus mode. For example, a workspace for first-person gaming experiences may be presented within a virtual environment that surrounds the user by views of space, e.g., stars, galaxies, etc. Such virtual content (e.g., the virtual environment) may replace the user's surroundings in the user's current view when the user enters the workspace. The change may be gradual to reduce disorientations or otherwise provide a more comfortable transition into a workspace.

Various implementations disclosed herein provide mechanisms for a system to learn and store where a user positions applications, e.g., relative to the user, relative to another reference object, or within particular real or virtual 3D spaces. In one example, a user specifies a workspace that defines the spatial arrangement of a set of one or more applications as a workspace and turns their device off. When the user later turns the device back on and the workspace is invoked, the applications (e.g., their user interfaces) are restored to the spatial arrangement specified by the workspace without necessarily requiring the user to reposition the applications.

In some implementations, the invoking of a workspace, the positioning of applications based on the workspace, or both, are based upon the system recognizing the user's current environment, e.g., what building or room the user is in, where the user is relative to certain types of furniture or objects, what activity the user is currently engaged or interested in, etc. Positioning information, e.g., from global positioning system (GPS), computer vision, simultaneous localization and mapping (SLAM), or other localization techniques may be used to recognize where a user is or what is in the user's proximate environment (e.g., within the same room). This information may be used to invoke or implement a workspace. For example, a user's work workspace may be automatically invoked when the user enters their home office. As another example, a user's work workspace may be implemented with an application over a desk if a desk is in the user's physical environment but, otherwise (e.g., if there is no desk) the application may be positioned at a distance directly in front of the user's current position when the workspace is invoked. Similarly, a type of environment may be identified (e.g., bedroom, office, kitchen, etc.) and the invoking or implementation of a workspace may be based on determining that the user is in a particular type of environment, e.g., in any office, in any bedroom, in any kitchen, etc.

In some implementations, a user actively or intentionally creates a workspace. For example, the user may position, size, and otherwise configure a set of applications and then initiate a save workspace feature to save that configuration as a workspace. In other implementations, the system prompts a user to save a configuration as a workspace, for example, when certain conditions are identified. As examples, the system may prompt the user to save a workspace when a user leaves a physical location after configuring applications, when the user performs another activity indicative of concluding a set up or configuration, or when the user starts using applications after having spent time configuring the applications. The system may prompt the user to save a workspace, as additional examples, when the user initiates device shutdown, switches to another task, changes focus, etc. In some implementations, the system prompts a user to save a workspace based on detecting a type of application use, e.g., based on detecting applications being positioned on surfaces of a physical environment. In some implementations, a user gives permission for the system to automatically create workspaces in certain circumstances, such as one or more of the circumstances described above.

In some implementations, a workspace is invoked and applications are then positioned within a view of a virtual environment or an extended reality (XR) environment with an immersion level in which some portions (but not necessarily all portions) of the view are virtual. In such instances, the system may provide a warning or other message to the user that real world objects may between the user and the workspace applications, e.g., there may be a wall between the user and a word processing application user interface, and the user may be warned so the user can avoid unintentionally contacting the wall.

Workspaces may specify a system environment (e.g., a virtual environment or 3D objects to be included in an environment used by a workspace), a system environment immersion level (e.g., how much of a system/virtual environment versus a real world surroundings is shown during use of a workspace), audio settings (e.g., what audio content is playing, how loudly, from how many virtual speakers, locations of virtual speaker(s)), focus mode (e.g., work, personal, etc.), and other relevant settings.

Workspaces may specify other settings associated with particular tasks and activities, e.g., music, sounds, silence, distraction settings, lighting, etc. In one example, a user prefers to be very focused when writing e-mails and the workspace associated with writing e-mails may have a distraction limiting feature enabled, e.g., that cancels out ambient sounds or that plays a type of music that helps the user focus.

Workspaces may specify peripheral and hardware device usage. For example, a user may prefer to work with a physical (e.g., Bluetooth hardware-based) keyboard when drafting documents and the associated workspace may specify the feature. When the user enters this workspace, the passthrough may show or highlight the physical keyboard and automatically trigger the keyboard connection, e.g., making the Bluetooth connection.

In some implementations, workspaces are configured to be invoked or implemented using timing criteria. In one example, a particular workspace may be invoked at a particular time each weekday or at a particular time relative to an event (e.g., 30 minutes before bed, 1 hour after breakfast). In another example, a workspace may be configured to change according to time requirements, e.g., show the e-mail application in the center for 30 minutes and then switch to show the spreadsheet application with a particular spreadsheet open for the next 45 minutes, etc.

In some implementations, a workspace is configured to be triggered by a shortcut or other relatively simple user action (e.g., a verbal command to an AI assistant, etc.). In some implementations, a user's focus (e.g., general activity status) is associated with a particular workspace. For example, when the user enters a workout focus (e.g., either automatically or manually), an associated workspace may be triggered. In some implementations, a workspace is invoked or implemented based on a combination of user focus and current environment. For example, if the user enters a work focus state and is in a room having a desk, then a work workspace may be automatically triggered.

Workspaces may be configured to encourage users to have desirable experiences, e.g., with unbroken states of productivity or flow, and simple transitions between tasks and activities. The system may be configured to create, invoke, and implement workspaces in ways that minimize the time and effort a user need spend configuring ideal or custom environments (e.g., with applications in ideal or custom configurations, appropriate content loaded into the applications, etc.), leaving the user free to spend more time participating in their desired tasks and activities.

In some implementations, a user's state (e.g., associated with a current activity, a current interest, a current level of tiredness, a time of day, etc.) is associated (automatically or manually) with a focus mode. The system may be configured to create, invoke, and implement workspaces in ways that account for the user's focus or focus changes. For example, when the user's focus changes, a workspace change may be initiated that changes the applications that the user is viewing and/or how applications are configured, e.g., positioned, sized, populated with content, etc. In one example, as a user's focus changes, one application is emphasized (e.g., enlarged, positioned directly in front of the user, etc.) while another application is de-emphasized (e.g., reduced, repositioned to the user's periphery, etc.). In some implementations, a number of applications being presented to a user depends on the user's workspace or an associated focus mode, e.g., reducing the number of applications to a small number (e.g., 1, 2, 3, etc.) when the user enters a concentration focus, a study focus, or the like. In particular workspaces or associated focus modes, applications may be closed down or hidden from view.

Hardware or software input or output mechanisms may be associated with particular workspaces or an associated focus modes. In one example, a user switches into a work focus mode and this switch triggers a word processing application with a last edited application to be presented in the user interface, as well as automatically triggering a connection to a Bluetooth keyboard below the user interface. The identification of the hardware keyboard to connect to (and the determination to connect to it) may be based on determining that this device was used the last time the user was in this workspace or associated focus mode and detecting that the keyboard is available, e.g., in the environment and currently connectable. In some implementations, the positioning of application content is tied to hardware components. In the prior example, the user interface may be positioned to appear to be a predetermined distance above the keyboard. The user may have previously setup or used the workspace and manually positioned the application's user interface in a spatial relationship to the hardware (e.g., 6 inches above and 10 inches further away from the user than the front of the keyboard, etc.). This relative spatial arrangement (e.g., the relationship to the keyboard) may be stored for the workspace so that when the user later uses the workspace, the user interface can be automatically positioned based on the prior spatial relationship hardware (e.g., 6 inches above and 10 inches further away from the user than the front of the keyboard's current position, etc.). The workspace may also store preference information regarding virtual input device usage (e.g., virtual keyboards, etc.). For example, the workspace may recognize that the user pulls up a virtual keyboard when the user has moved away from the hardware keyboard. This information may be stored in the workspace and used to automatically initiate the display of the virtual keyboard when the user moves away from the hardware keyboard on subsequent occasions.

A workspace may store information about an intended immersion level, e.g., identifying percentages of real versus virtual environments that will be visible or particular physical objects that will be visible. For example, a workspace may specify an environment that is mostly virtual, but in which certain physical objects from the real world are visible. For example, the user's desk, physical keyboard, and physical mouse may be visible and surrounded by otherwise virtual environments.

Some implementations facilitate a user to create or define a workspace in ways that make doing so intuitive or otherwise easy for the user. In one example, the system recognizes that a user is in a particular environment doing a particular type of activity, e.g., the user is in a home office with notifications turned off and using applications that the user spent time or effort positioning. The system, based on recognizing such context, may prompt the user to save the workspace (or focus associated with the workspace) for future use. It may prompt the user to provide a name for a workspace. The system may prompt the user to specify future context cues that will trigger automatic entry into the workspace, e.g., recognizing that the user is in the same room at particular times of day, the user is sitting down at the desk in the room, etc. E-mail, text messages, phone calls, and the other communications can also provide contextual information used to determine when to ask a user to save a workspace or automatically reenter a workspace. For example, a workspace may be triggered automatically whenever a user receives an e-mail or phone call from their supervisor during working hours.

A user may specify a focus mode for a particular context (e.g., whenever the user is in their living room between 5 μm and 9 pm). The system may recognize certain application usage (e.g., user effort configuring applications) and/or repeated positioning or use (e.g., pattern detection) of certain applications and ask the user if a workspace should be created and associated with the focus mode so that applications or application configurations will be automatically provided when the focus is active.

In some implementations, a given workspace may present applications differently for different contexts, e.g., in different rooms, at different times of day, when the user is involved in different activities. For example, an art creation workspace may present applications in different positions when the user is in the living room (e.g., color picker on the coffee table, art canvas application on the wall, etc.) versus when the user is in the basement (e.g., color picker on the billiards table, art canvas application on the art desk). In some implementations, a workspace defines application placement based on object or surface types, e.g., position an art picker on a horizontal flat surface at least 1 foot above the floor and an art canvas application on a flat surface this is vertical or within a predetermined angle threshold of vertical. A workspace may configure applications based on the available space, balancing the workspace spatial positioning specification with the physical environment in which the workspace is activated. The system may attempt to position applications according to a workspace on flat surfaces or open space whenever possible and, otherwise, position the applications in a way that is as similar as possible to the intended spatial relationship without violating certain constraints, e.g., no applications above ceiling height, no applications with a wall in between the user and the application, etc. In some implementations, a workspace defines positioning rules for spatially positioning, sizing, or otherwise configuring applications.

Some implementations provide one or more user interface features or affordances that a user can select or activate to easily switch between different workspaces. Doing so may enable the user to multi-task more easily, e.g., switching between different tasks every couple of minutes or more frequently when necessary without losing the spatial arrangements, configurations, and last-used states that are optimized and current for the user's different tasks, e.g., each workspace may have applications configured for a different task that the user can switch amongst. Similarly, if the system crashes or reboots, the user can be quickly restored to their prior activity by restoring the workspace (e.g., application configuration and related application content/state). User activity can be automatically persisted via workspaces so that the user does not lose application configuration, content, or state when interrupted.

Some implementations provide workspaces that specify audio configurations or content, e.g., the 3D location of virtual speakers, volume levels, audio content to be played, etc. In some implementations, the 3D locations of virtual speakers are determined based on a workspace's audio positioning rules, e.g., position speakers in the corners of the room, on the ceiling 5 feet from the user. User audio configurations and content may be manually specified by a user or automatically determined based on prior user audio configuration activity.

Persistence characteristics of applications or content may additionally be specified by a workspace. For example, a virtual keyboard may be displayed only when the user has an application open in which a text field is active or always displayed. Such persistence (or lack of persistence) may be specified by the workspace. Persistence may depend on context. Thus, a given workspace may specify that a virtual keyboard is persistent (always displayed) if the user is in an office type of room but not persistent (only displayed if a text field is active) in other types of rooms.

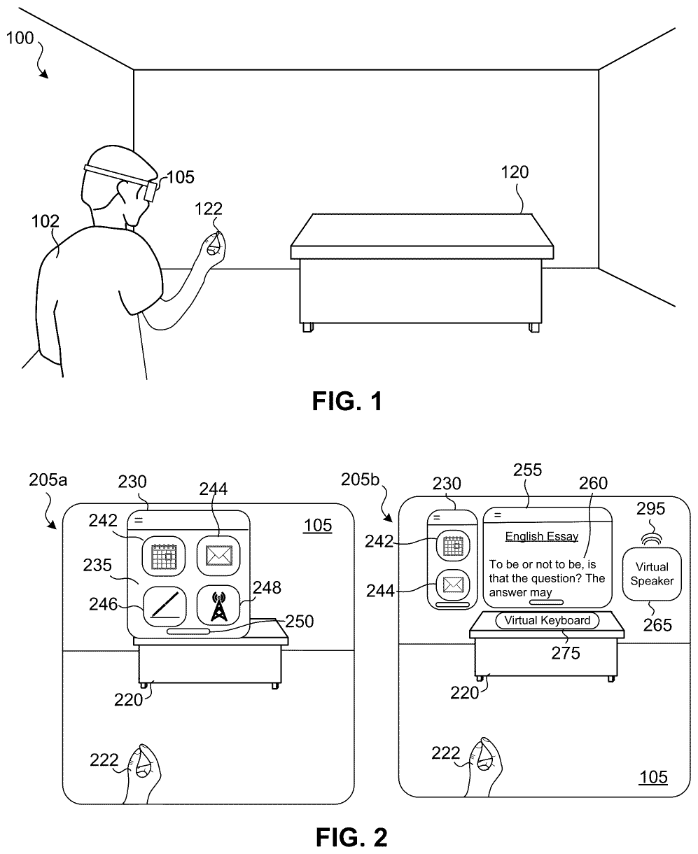

FIG. 1 illustrates an exemplary electronic device 105 operating in a physical environment 100. In the example of FIG. 1, the physical environment 100 is a room that includes a desk 120. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 or user 102 may be used to provide visual and audio content or to identify the current location of the physical environment 100 or the location of the user or other objects within the physical environment 100.

In some implementations, views of an extended reality (XR) environment may be provided to one or more participants (e.g., user 102 and/or other participants not shown) via electronic device 105 (e.g., a wearable device such as an HMD, a handheld device such as a mobile device, a tablet computing device, a laptop computer, etc.). Such an XR environment may include views of a 3D environment that are generated based on camera images and/or depth camera images of the physical environment 100, as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100. Such an XR environment may include virtual content that is positioned relative to a position of the user 102 or another object in the physical environment.

In some implementations, video (e.g., pass-through video depicting a physical environment) is received from an image sensor of a device (e.g., device 105). In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

FIG. 2 illustrates views of an XR environment provided by the device 105 of FIG. 1 in which the user 102 positions and uses applications. Note that the term “application” refers generally to content items (executable or not executable) that can be provided within an XR environment.

View 205a of the XR environment includes an exemplary user interface element 230 depicting a user interface of an application (e.g., an example of virtual content) and a depiction 220 of the desk 120 (e.g., an example of real content). Providing such views may involve determining 3D attributes of the physical environment 100 and positioning the virtual content, e.g., user interface element 230, in a 3D coordinate system corresponding to that physical environment 100.

In this example, the background portion 235 of the user interface element 230 is flat. In this example, the background portion 235 includes aspects of the user interface element 230 being displayed except for the feature icons 242, 244, 246, 248. Displaying a background portion of a user interface of an operating system or application as a flat surface may provide various advantages. Doing so may provide an easy to understand or otherwise useful portion of an XR environment for accessing the user interface of an application. The user interface element 230 includes various user interface features, including a background portion 235 and icons 242, 244, 246, 248, and window movement icon 250. The icons 242, 244, 246, 248, 250 may be displayed on a flat front surface of user interface 230. The user interface element 230 may provide a user interface of an application, as illustrated in this example. The user interface element 230 is simplified for purposes of illustration and user interfaces in practice may include any degree of complexity, any number of content items, and/or combinations of 2D and/or 3D content. User interface elements may be provided by operating systems and/or applications of various types including, but not limited to, messaging applications, web browser applications, content viewing applications, content creation and editing applications, or any other applications that can display, present, or otherwise use visual and/or audio content.

In view 205a of the XR environment, the user interface element 230 is for an application management application (e.g., an application containing icons 242, 244, 246, 248 used to launch other applications) that is positioned at a default 3D position relative 3D physical environment of FIG. 1. In this example, the user performs various input gestures using hand 122 (shown as depiction 222 in the views 205a-b of FIG. 2) to reconfigure the user interface element 230 of the application management application and launch, position, and use other applications. As shown in view 205b, the user 102 has repositioned (e.g., to the left) and shrunk the size of the user interface element 230 of the application management application so that only icons 242 and 244 are visible within its boundaries. The user 102 has also launched a document editing application using icon 246 and positioned the corresponding application user interface 255 above the depiction of the desk 220. The user also positioned a virtual keyboard 275 on the top surface of the depiction of the desk 220 and positioned a virtual speaker 265 on the wall of the XR environment (which corresponds to the wall of the physical environment 100). This configuration (e.g., spatial relationships, positioning, sizing, etc.) is stored in a workspace for the user (e.g., a workspace named “work”).

In addition to configuring the application content as shown in view 205b, the user 102 also launches an audio application to begin playing music 295 from the virtual speaker 265. In addition, the user also begins creating a document using the user interface 255 of the document editing application, e.g., typing “English Essay” and “To be or not to be is that the question? The answer may”. The information about the content and state of the applications in the workspace are also stored for the workspace, e.g., identifying the current music that is playing, the current volume of the music that is playing, the document that is open (and its current scroll position) in the user interface 255 of the document editing application, including any content the user has added such as the text noted above.

The workspace may store application configuration information, e.g., application positioning and sizing information, for the applications. It may store information about such user interface being at fixed positions and orientations within a 3D environment. In such cases, after the applications are positioned and sized, user movements would not affect the position or orientation of the user interfaces within the 3D environment. In other cases, user movements will affect the initial position and/or orientation of the user interfaces within the 3D environment. The user 102 may intentionally (or unintentionally) perform movements that result in repositioning of the user interface within the 3D environment. For example, a given user interface of an application may maintain its position 3 feet in front of the user's torso and thus move as the user turns and moves around. A workspace may specify configuration of application relative to a fixed coordinate system of an environment, or relative to another anchor such as the user or a particular object in the environment. In some implementations, some applications are positioned relative to a fixed coordinate system while other applications are positioned relative to a user or object that may be moved within that fixed coordinate system.

In some implementations, a workspace specifies an orientation of an application relative to a fixed coordinate system or a reference object. For example, a user interface of an application may have a flat portion (e.g., background portion 235) that workspace specifies is to be positioned in a generally orthogonal orientation such that it always generally faces the user's torso, e.g., is orthogonal to a direction (not shown) from the user to the user interface. For example, providing such an orientation may involve reorienting the user interface when the user moves and/or when the user provides input changing the positioning of the user interface such that the flat portion remains generally facing the user.

In some implementations, a workspace specifies an initial or default position of one or more applications within a 3D environment (e.g., when the workspace is first initiated). Such initial/default positioning may be based on the positions and orientations of the objects (relative to the environment, user, or other object) when the workspace was created, last used, or last saved. The workspace may specify positioning rules that account for various criteria including, but not limited to, criteria that accounts for application type, application functionality, content type, content/text size, environment type, environment size, environment complexity, environment lighting, presence of others in the environment, presence of particular objects or types of objects in the environment, use of an application by multiple users, user preferences, user input, and numerous other factors.

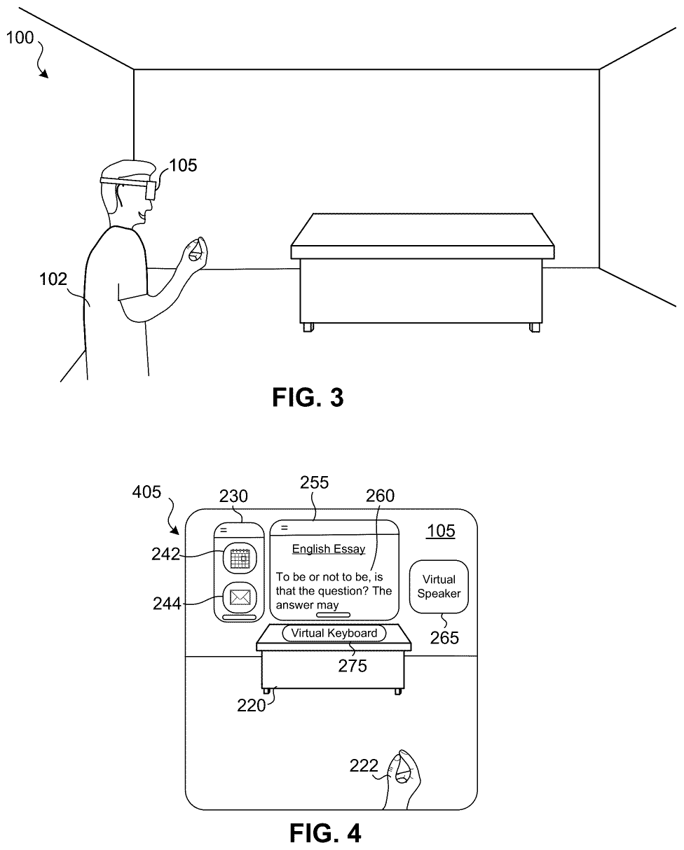

FIG. 3 illustrates the user 102 returning to the physical environment of FIG. 1 at a later time. FIG. 4 illustrates a view 405 of an XR environment provided by the device 105 of FIG. 3 in which application positioning and content state is provided based on application positioning and content state from a prior activity associated with a workspace. In view 405, the applications are configured and their content is presented based on information stored in the “work” workspace to match the configuration and state of the view 205b of FIG. 2. This view 405 is provided without the user 102 needing to do any new configuration of applications, opening/scrolling of documents, turning on of the audio, setting the volume, etc.

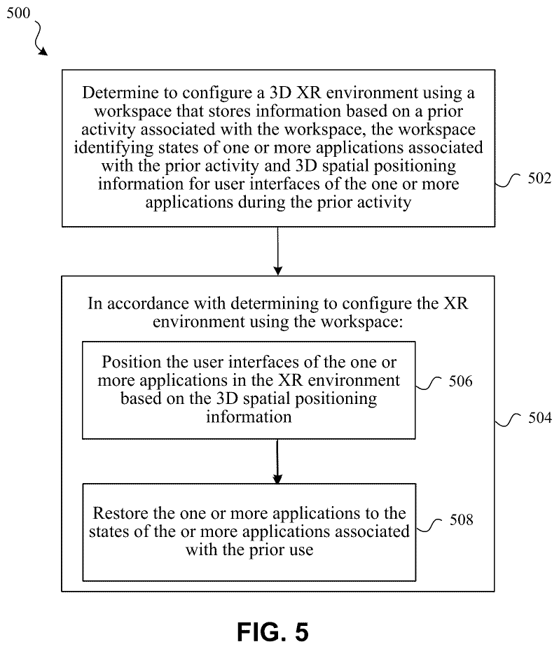

FIG. 5 is a flowchart illustrating a method 500 for configuring applications and restoring application content based on workspace associated with a prior activity. In some implementations, a device such as electronic device 105, performs method 500. In some implementations, method 500 is performed on a mobile device, desktop, laptop, HMD, or server device. The method 500 is performed by processing logic, including hardware, firmware, software, or a combination thereof. In some implementations, the method 500 is performed on a processor executing code stored in a non-transitory computer-readable medium (e.g., a memory).

At block 502, the method 500 involves determining to configure a three-dimensional (3D) extended reality (XR) environment using a workspace that stores information based on a prior activity associated with the workspace, the workspace identifying states of one or more applications associated with the prior activity and 3D spatial positioning information for user interfaces of the one or more applications during the prior activity. In some instances, the activity is workspace creation and the states and 3D positions may be based on the states and 3D positions of the applications at the end of the workspace creation activity. In some instances, the activity is a subsequent use of an already-created workspace and the states and 3D positions may be based on the states and 3D positions of the applications at the end of that session.

At block 504, the method 500 involves, in accordance with determining to configure the XR environment using the workspace, performing blocks 506 and 508. In block 506, the method 500 involves positioning the user interfaces of the one or more applications in the XR environment based on the 3D spatial positioning information. In block 508, the method 500 involves restoring the one or more applications to the states of the or more applications associated with the prior use.

Various types of alternative or additional information may be stored in a workspace. In some implementations, the workspace stores application sizing information for the one or more applications based on sizes of the one or more applications associated with the prior activity, wherein the applications are sized in the XR environment in accordance with the application sizing information.

In some implementations, the workspace stores environment information for the one or more applications based on a virtual 3D environment associated with the prior activity, where the XR environment is configured with at least partial immersion of the one or more applications within the virtual 3D environment in accordance with the environment information. A warning or other message may be presented or manual input required before automatically switching to immersion.

In some implementations, the workspace stores audio information based on the prior activity, where the XR environment is configured to present audio based on the audio information. The audio information may comprise, as examples, a volume level or identify playback audio. The audio information may identify 3D positions of spatial audio sources, where the XR environment is configured to present the audio based on the 3D positions of the spatial audio sources.

In some implementations, the workspace stores hardware accessory information based on the prior activity, where the XR environment is configured based on the hardware accessory information. For example, a user interface element may be positioned relative to a physical keyboard, mouse, etc., overlaying a virtual keyboard on a real keyboard, etc.

A workspace may be triggered for use in various ways. In some implementations, use of the workspace to configure the XR environment is triggered based on a current context satisfying a workspace context trigger criterion. The workspace context trigger criterion may require that: an HMD be in a particular geographic area; the HMD be in a particular building or campus; the HMD be in a particular room or type of room; the HMD be in a room that has one or more particular items (e.g., desk, bed, refrigerator, etc.), etc. In some implementations, the workspace context trigger criterion requires that a current time or day be within a particular time or day range or occur within one or more particular days. In some implementations, use of the workspace to configure the XR environment is triggered based on user input manually initiating use of the workspace. In some implementations, use of the workspace to configure the XR environment is triggered based on determining that a focus or type of focus has been initiated.

In some implementations, the spatial positioning specified by a workspace identifies 3D positions for one or more of the one or more applications relative to a position of the user, e.g., the user's body, an HMD being worn by the user, or another reference object. The spatial positioning may be based on the user or device/object at the time the workspace is initiated and then remain fixed. Alternatively, the applications may be positioned relative to the user/device/object and constantly change as the user/device/objects changes positions.

In some implementations, the spatial positioning specified by a workspace identifies fixed 3D positions for one or more of the one or more applications relative an object (e.g., desk) or type of object (e.g., any desk).

In some implementations, the positioning of workspace content is world-locked when the workspace is triggered in a specific location, but can be positioned relative to the user when the workspace is triggered elsewhere or when the workspace does not have an associated physical location. In some implementations, when a position of the user corresponds to a particular location, the spatial applications relative an object or type of object, and when the position of the user does not correspond to the particular location, the spatial positioning identifies 3D positions for one or more of the one or more applications relative to the position of the user.

Positioning of a user interface of the one or more applications in the XR environment may further be based on a scene understanding of a physical environment in which the HMD is operated. Such a scene understanding may be based on sensor data obtained via one more sensors on the HMD.

A workspace may be initially created and then updated or changed based, for example, on the user's use of the workspace. In some implementations, a workspace is created by a user manually specifying application configuration or state. In some implementations, prior activity upon which a workspace is based is an initial creation of the workspace in which a user manually positions or changes the states of the one or more applications. In some implementations, the prior activity upon which a workspace is based is a use of the workspace following a prior creation and storage of the workspace, where the workspace is changed based on a user manually positioning or changing the states of the one or more applications during the use.

In some implementations, method 500 further involves determining to transition the XR environment using a second workspace that stores information based on a second prior activity associated with the second workspace, the second workspace identifying second states of one or more applications associated with the second prior activity and second 3D spatial positioning information for user interfaces of the one or more applications during the second prior activity and configuring the XR environment using the second workspace.

In some implementations, notifications provided while a user is using a given workspace are limited based on the workspace, e.g., based on notification setting specified by the workspace such as a notification setting that only enables notifications associated with certain applications, people, or sources.

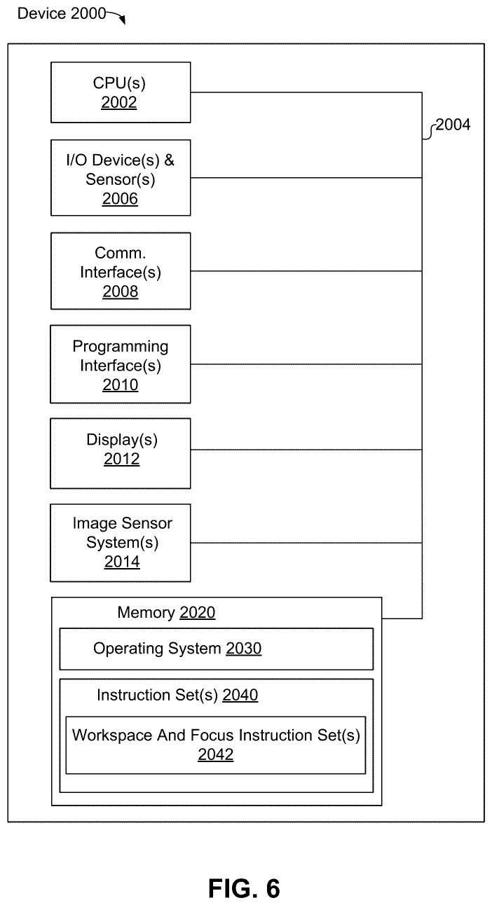

FIG. 6 is a block diagram of electronic device 2000. Device 2000 illustrates an exemplary device configuration for electronic device 105 (or any of the other electronic devices described herein). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 2000 includes one or more processing units 2002 (e.g., microprocessors, ASICs, FPGAs, GPUs, CPUs, processing cores, and/or the like), one or more input/output (I/O) devices and sensors 2006, one or more communication interfaces 2008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 2010, one or more output device(s) 2012, one or more interior and/or exterior facing image sensor systems 2014, a memory 2020, and one or more communication buses 2004 for interconnecting these and various other components.

In some implementations, the one or more communication buses 2004 include circuitry that interconnects and controls communications between system components. In some implementations, the one or more I/O devices and sensors 2006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 2012 include one or more displays configured to present a view of a 3D environment to the user. In some implementations, the one or more displays 2012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 2000 includes a single display. In another example, the device 2000 includes a display for each eye of the user.

In some implementations, the one or more output device(s) 2012 include one or more audio producing devices. In some implementations, the one or more output device(s) 2012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 2012 may additionally or alternatively be configured to generate haptics.

In some implementations, the one or more image sensor systems 2014 are configured to obtain image data that corresponds to at least a portion of a physical environment. For example, the one or more image sensor systems 2014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 2014 further include illumination sources that emit light, such as a flash. In various implementations, the one or more image sensor systems 2014 further include an on-camera image signal processor (ISP) configured to execute a plurality of processing operations on the image data.

The memory 2020 includes high-speed random-access memory, such as DRAM, SRAM, DDR RAM, or other random-access solid-state memory devices. In some implementations, the memory 2020 includes non-volatile memory, such as one or more magnetic disk storage devices, optical disk storage devices, flash memory devices, or other non-volatile solid-state storage devices. The memory 2020 optionally includes one or more storage devices remotely located from the one or more processing units 2002. The memory 2020 comprises a non-transitory computer readable storage medium.

In some implementations, the memory 2020 or the non-transitory computer readable storage medium of the memory 2020 stores an optional operating system 2030 and one or more instruction set(s) 2040. The operating system 2030 includes procedures for handling various basic system services and for performing hardware dependent tasks. In some implementations, the instruction set(s) 2040 include executable software defined by binary information stored in the form of electrical charge. In some implementations, the instruction set(s) 2040 are software that is executable by the one or more processing units 2002 to carry out one or more of the techniques described herein.

The instruction set(s) 2040 include workspace and focus instruction set(s) 2042 configured to, upon execution, create, store, modify, or use workspaces and focus modes, as described herein. The instruction set(s) 2040 may be embodied as a single software executable or multiple software executables.

Although the instruction set(s) 2040 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method, comprising:
at a head mounted device (HMD) having a processor:
determining to configure a three-dimensional (3D) extended reality (XR) environment using a workspace that stores information based on a prior activity associated with the workspace, the workspace identifying states of one or more applications associated with the prior activity and 3D spatial positioning information for user interfaces of the one or more applications during the prior activity; and
in accordance with determining to configure the XR environment using the workspace:
positioning the user interfaces of the one or more applications in the XR environment based on the 3D spatial positioning information; and
restoring the one or more applications to the states of the or more applications associated with the prior use.

2. The method of claim 1, wherein the workspace further stores application sizing information for the one or more applications based on sizes of the one or more applications associated with the prior activity, wherein the applications are sized in the XR environment in accordance with the application sizing information.

3. The method of claim 1, wherein the workspace further stores environment information for the one or more applications based on a virtual 3D environment associated with the prior activity, wherein the XR environment is configured with at least partial immersion of the one or more applications within the virtual 3D environment in accordance with the environment information.

4. The method of claim 1, wherein the workspace further stores audio information comprising a volume level or identifies playback audio, wherein the audio information is based on the prior activity, wherein the XR environment is configured to present audio based on the audio information.

5. The method of claim 4, wherein the audio information identifies 3D positions of spatial audio sources, wherein the XR environment is configured to present the audio based on the 3D positions of the spatial audio sources.

6. The method of claim 1, wherein the workspace further stores hardware accessory information based on the prior activity, wherein the XR environment is configured based on the hardware accessory information. (e.g., positioning UI relative to a physical keyboard, mouse, etc., overlaying a virtual keyboard on a real keyboard).

7. The method of claim 1, wherein determining to configure the XR environment using the workspace is triggered based on a current context satisfying a workspace context trigger criterion.

8. The method of claim 7, wherein the workspace context trigger criterion requires that:
the HMD be in a particular geographic area;
the HMD be in a particular building or campus;
the HMD be in a particular room or type of room; or
the HMD be in a room that has one or more particular items.

9. The method of claim 7, wherein the workspace context trigger criterion requires that a current time or day be within a particular time range or on one or more particular days.

10. The method of claim 1, wherein determining to configure the XR environment using the workspace is triggered based on user input manually initiating use of the workspace.

11. The method of claim 1, wherein determining to configure the XR environment using the workspace is triggered based on determining that a type of focus has been initiated.

12. The method of claim 1, wherein the spatial positioning identifies 3D positions for one or more of the one or more applications relative to a position of the user.

13. The method of claim 1, wherein the spatial positioning identifies fixed 3D positions for one or more of the one or more applications relative an object or type of object.

14. The method of claim 1, wherein:
when a position of the user corresponds to a particular location, the spatial positioning identifies fixed 3D positions for one or more of the one or more applications relative an object or type of object; and
when the position of the user does not correspond to the particular location, the spatial positioning identifies 3D positions for one or more of the one or more applications relative to the position of the user.

15. The method of claim 1, wherein positioning the user interfaces of the one or more applications in the XR environment is further based on a scene understanding of a physical environment in which the HMD is operated, the scene understanding based on sensor data obtained via one more sensors on the HMD.

16. The method of claim 1 further comprising:
determining to transition the XR environment using a second workspace that stores information based on a second prior activity associated with the second workspace, the second workspace identifying second states of one or more applications associated with the second prior activity and second 3D spatial positioning information for user interfaces of the one or more applications during the second prior activity; and
configuring the XR environment using the second workspace.

17. The method of claim 1, wherein the prior activity is an initial creation of the workspace in which a user manually positions or changes the states of the one or more applications.

18. The method of claim 1, wherein the prior activity is a use of the workspace following a prior creation and storage of the workspace, wherein the workspace is changed based on a user manually positioning or changing the states of the one or more applications during the use.

19. The method of claim 1, wherein notifications are limited based on the workspace.

20. A system comprising:
memory; and
one or more processors coupled to the memory, wherein the memory comprises program instructions that, when executed by the one or more processors, cause the system to perform operations comprising:
determining to configure a three-dimensional (3D) extended reality (XR) environment using a workspace that stores information based on a prior activity associated with the workspace, the workspace identifying states of one or more applications associated with the prior activity and 3D spatial positioning information for user interfaces of the one or more applications during the prior activity; and
in accordance with determining to configure the XR environment using the workspace:
positioning the user interfaces of the one or more applications in the XR environment based on the 3D spatial positioning information; and
restoring the one or more applications to the states of the or more applications associated with the prior use.

21. A non-transitory computer-readable storage medium, storing program instructions executable by one or more processors to perform operations comprising:
determining to configure a three-dimensional (3D) extended reality (XR) environment using a workspace that stores information based on a prior activity associated with the workspace, the workspace identifying states of one or more applications associated with the prior activity and 3D spatial positioning information for user interfaces of the one or more applications during the prior activity; and
in accordance with determining to configure the XR environment using the workspace:
positioning the user interfaces of the one or more applications in the XR environment based on the 3D spatial positioning information; and
restoring the one or more applications to the states of the or more applications associated with the prior use.
